(19) United States
(12) Patent Application Publication
(10) Pub. No.: US 2002/0139292 A1
(43) Pub. Date: Oct. 3, 2002

(54) Medication dosage reminder device

(76) Inventor: Harry Giewercer, Richmond Hill (CA)

Correspondence Address: Harry Giewercer, 29 Hyde Park Drive, Richmond Hill, L4B 1V2, CA

(21) Appl. No.: 10/050,520

(22) Filed: Jan. 18, 2002

Related U.S. Application Data
(60) Provisional application No. 60/263,243, filed on Jan. 23, 2001.

(51) Int. Cl. G09F 9/302

(52) U.S. Cl. 116/308

(57) ABSTRACT

A medication dosage reminder device (100) operating on the exterior wall surface of a medication container (C) includes a band support (110) on the wall and a flexible band (132) continuously mounted (132m) closely around the wall of the container, above the band support. A single device is suitable for a large variety of common medication container shapes and sizes. Mating contact areas (112) (136), on the two members limit movement of the mounted band when they are selectively engaged. The mounted band is otherwise free to rotate about the container. Co-operating indicia on the device include an indicator pointer (138) and dosage time periods (120) that may be inscribed (122) to establish a highly customized dosage schedule. A patient rotates the band to indicate the next scheduled dosage time period. The indicator pointer and the scheduled dosage time period form a reminder indicating when the next dose is due or when the last dose was taken.

### CROSS-REFERENCE TO RELATED APPLICATIONS

This application claims the benefit of the priority of Provisional Patent Application number 60/263,243 filed on Jan. 23, 2001 titled Medication Dosage Reminder Device.

### BACKGROUND

1. Field of Invention

The present invention relates to a device for reminding a patient to take his next dose of medication. More specifically, the invention provides a simple visual representation of the patient's dosage schedule for a particular medication, and when the next dose is due or when the last dose was taken.

2. Discussion of Prior Art

Devices and methods to help patients follow a medication regimen are not a new phenomenon. On Dec. 8, 1885, U.S. Pat. No. 332,208 was granted to J. S. Noel for a “TIME DOSE-INDICATOR FOR BOTTLES”, consisting of a series of dials and a window. Even at that time his invention offered new and useful improvements over previous designs. More complex and costlier devices and means are also described in the art. For example, U.S. Pat. No. 5,752,235 granted to Kehr, et al. On May 12, 1998 for an, “ELECTRONIC MEDICATION MONITORING AND DISPENSING METHOD” describes a device having a plurality of compartments for storing medication and an electrical signaling system to emit medication alert signals from time to time.

There is a definite need for improving what the medical profession calls “patient compliance”, but it is evident that to date, the inventive art has not adequately met the challenge. The more complex of these devises and systems offer far more features and control than what the vast majority of patients require. Their costs are also prohibitive. With the advancing average age of patients and their increased reliance on multiple concomitant self-administered medicines, there is a growing unfulfilled need for a simple, acceptable mass-market compliance aid. A device that is most likely to gain broad acceptance is one that conserves the current well established medication delivery packaging and one that compliments rather than changes dispensing and consumption procedures.

Many reminder devices that work with standard medication containers exist in the art, however they do not seem to have become widely available. It is believed that these prior devices have shortcomings such as undue complexity, cost of manufacture, applicability to only some containers and requirement of special skills. Failing to provide for simple customization by the patient or pharmacist has also been an obstacle to acceptance, because it resulted in a device of limited application or necessitated the production of a great variety of devices.

For example, U.S. Pat. No. 3,996,879 granted to Vilma E. Walton on Dec. 14, 1976 for a, “REMINDER DEVICE FOR MEDICINE AND THE LIKE”, describes a device having an open ended collar that mounts on a cylindrical shaped container such as a vial. A display unit with windows is mounted on the collar. The display unit has a spring loaded and movable slide element to selectively cover a window and its associated notation. Because medication containers have various shapes and sizes, a wide variety of such devices would have to be manufactured. Both the collar and display unit, are molded and the display unit is very intricate, making the device costly to produce.

U.S. Pat. No. 6,032,609 granted to Van A. Luoma on Mar. 7, 2000 for a “DOSAGE INDICATOR MEDICINE CONTAIN” describes a system for permanently recording the taking of medication directly on a disk or strip. This record also serves to indicate if the medication was taken. The disk may be affixed to the top of a medication closure and the strip may be affixed to the wall surface of a medication container. A number of different possible ways to indicate the recording are described. All require appropriate indicia on the disk and strip and all require the patient to irreversibly mark a specific predetermined location on the disk and strip. In practice this device is not practical for use on small containers. It is not uncommon for patients to take medication three or four times a day and have a thirty-day supply in one container. Frequently these containers are quite small and the prescription label occupies much of the container surface. In order to have the indicia contain the required information, the printing could get very small and crowded. The strip would also likely occlude necessary information on the prescription label. The inventor suggests stacking disks and strips one on another in cases where a single disk or strip may not be able to display all the dosage events for the medication in the container. This can become cumbersome and demands a certain degree of dexterity, which not all patients may have. Even if the strip could be positioned above or below the prescription label, marking a disk or strip in an exact small area could be problematic and prone to irreversible errors. A significant number of patients who could most benefit from a reminder device, are in an age group that generally suffers from reduced vision and reduced dexterity, making correct use of the device difficult. Every self-administered self-controlled program is subject to human error and defeat. A permanent record does not necessarily offer any increased assurance of compliance over any other compliance aid. Furthermore, recording the taking of medication is not necessary in most cases. These devices could also get inadvertently marked when carried in a pocket or purse. Given that these devices rely on irreversible marking to record an event, customization by the pharmacist or patient does not appear to be simple or practical.

U.S. Pat. No. 6,152,067 granted to Ronald Grant Mathison on Nov. 28, 2000 for a “MEDICATION DOSAGE REMINDER DEVICE” describes a device having a hub that attaches to a medication container and an annular dial. The dial is further pinned between the hub and the container by a portion of the hub, but is otherwise free to rotate about the hub. When the dial is rotated, a pointer on one and indicia on the other co-operate to indicate a dosage time. The device as illustrated, appears to occupy a considerable area of the container. It may occlude important prescription label information on small containers. Further reductions in size of the device may not be possible without adversely affecting legibility and ease of operation for some individuals as outlined above. The device does not appear to have a dependable way to secure a selected position and avoid inadvertent change in dial position or have a means to help the patient align the pointer. The device relies on pressure from a portion of the hub to retain a selected position, but the pressure must be light enough to permit a patient to rotate the dial. This pressure can vary because of handling of the device before application or change because of use. Because of the size constraints explained above, there would be a considerable variety of containers on which the patient could not view the device and the pharmacy label instructions at the same time. This would increase the possibility of error when setting the indicator.

### SUMMARY

The invention is a medication dosage reminder device including two members. The first member is a band support, which may be attached to the exterior wall surface of a medication container or alternatively is a medication container having a band support integrally formed on a wall. The second member is a flexible strip or band that is produced from sheet or roll stock such as paper, cardboard or plastic. This second member is continuously mounted closely around the exterior wall surface of the container above the band support so that it conforms to the wall surface but is otherwise free to rotate about the container. It is also axially displaceable above the band support, along the longitudinal axis of the container. Teeth and notches on the members allow for selective engagement that limits unwanted movement of the mounted band. One of the members carries dosage time period indicia referencing positions that are selectable by a pointer. A pharmacist or user may inscribe the dosage time period indicia in order to establish a customized dosage schedule in accordance with prescription label instructions. The other member acts as a pointer and is so indicated. Time periods are selected by turning the mounted band around the container. The indicator pointer and the scheduled dosage time period indicia form a reminder indicating when the next dose is due or when the last dose was taken.

Objects and Advantages

Accordingly, besides the objects and advantages of the medication dosage reminder device described in my above patent, several objects and advantages of the present invention are;

a) to provide a device that is suitable for most patients and one that can be used with most common medication containers;

b) to provide a device that minimizes the potential for error, through ease of use, legibility and logical positional placement on the medication container;

c) to provide a device that achieves these goals at a very low cost.

Further objects and advantages of my invention will become apparent from consideration of the drawings and ensuing description.

### DRAWING FIGURES

FIG. 1 is a perspective view of a preferred embodiment of my invention. In this example, the dosage reminder device is assembled on a typical medication container (vial) bearing a traditional pharmacy prescription label. The pharmacy prescription label and the medication container as depicted are not part of the invention.

FIG. 2 is a front view of the device of FIG. I as it appears prior to preparation for mounting, fitting and assembly on a medication container.

FIG. 3 is a perspective view of a transparent band like the band of FIG. 2, showing how it is formed into a continuous band. A medication container around which the band is normally mounted is omitted for clarity.

FIG. 4A is a side cross-sectional view of a device assembled as in FIG. 1.

FIG. 4B is a greatly enlarged, fragmentary, side cross-sectional view showing a device assembled on a medication container as in FIG. 1.

FIG. 5 is a front view of a variation of the device of FIG. 2.

FIG. 6 is a front view of another variation of the device of FIG. 2.

FIG. 7 is a front view of an additional second embodiment of my invention. In this example a pharmacy prescription label is an integral part of a band support.

FIG. 8 is a perspective view of an alternative third embodiment of my invention. In this example a band support is integral to a container (cardboard carton).

FIG. 9 is a side view of the container of FIG. 8, showing the integral band support.

FIG. 10 is a perspective view of a variation of a device like the one in FIG. 8 showing its use in a medication bottle container.

FIG. 11 is a side view of the container of FIG. 10 showing the integral band support.

FIG. 12 is a perspective view of another variation of a device like the one in FIG. 8 showing its use in a medication bottle container.

FIG. 13 is a perspective view of yet another variation of a device like the one in FIG. 8 showing its use in a medication bottle container.

FIG. 14 is a side view of the container of FIG. 13 showing the integral band support.

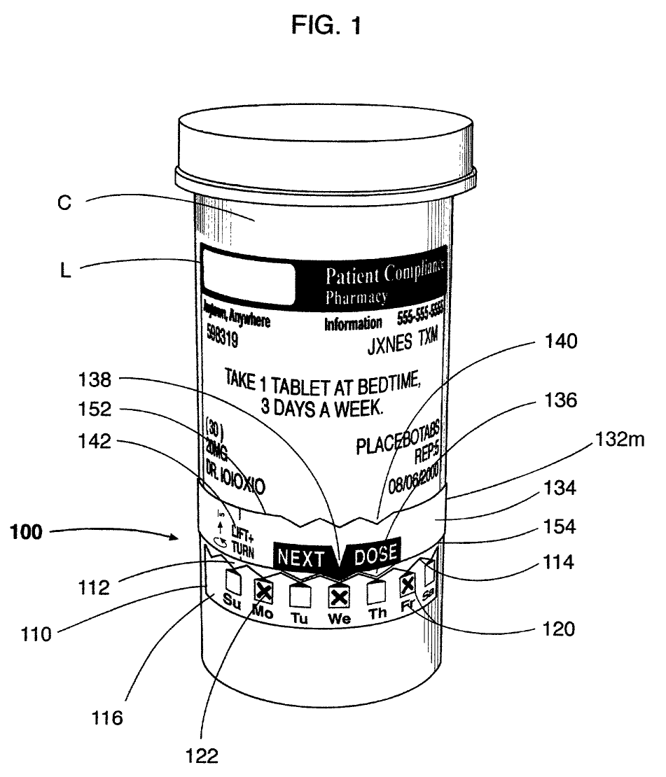

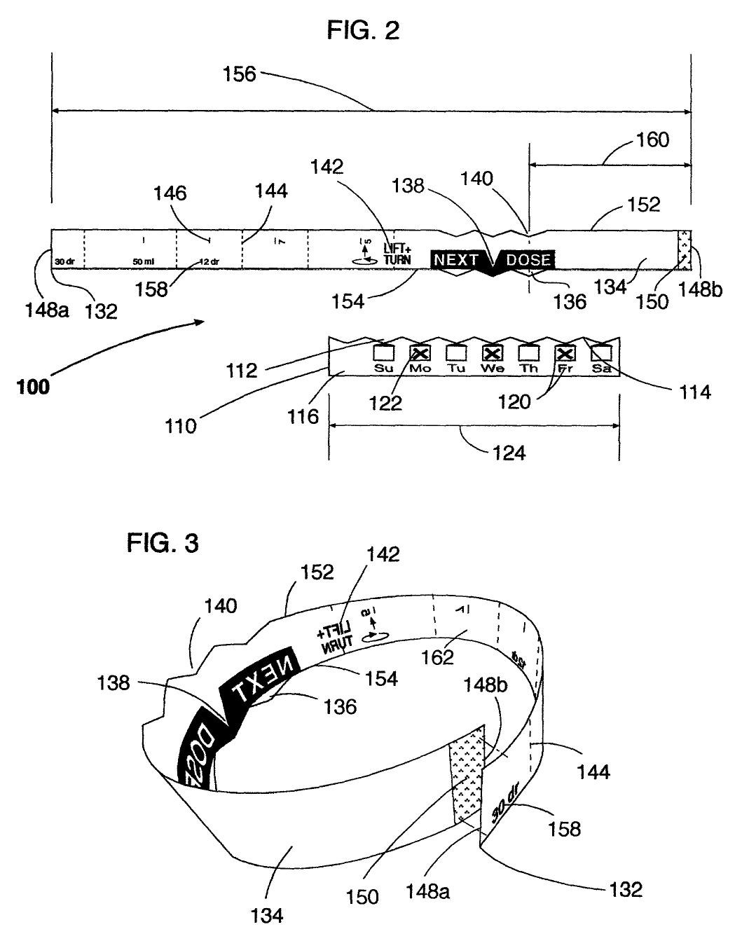

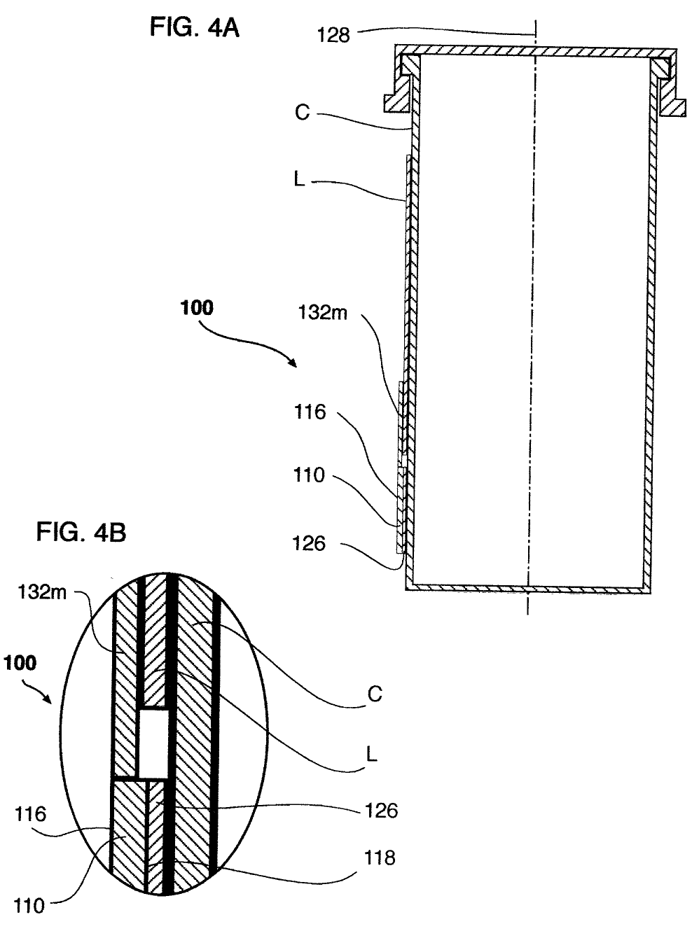

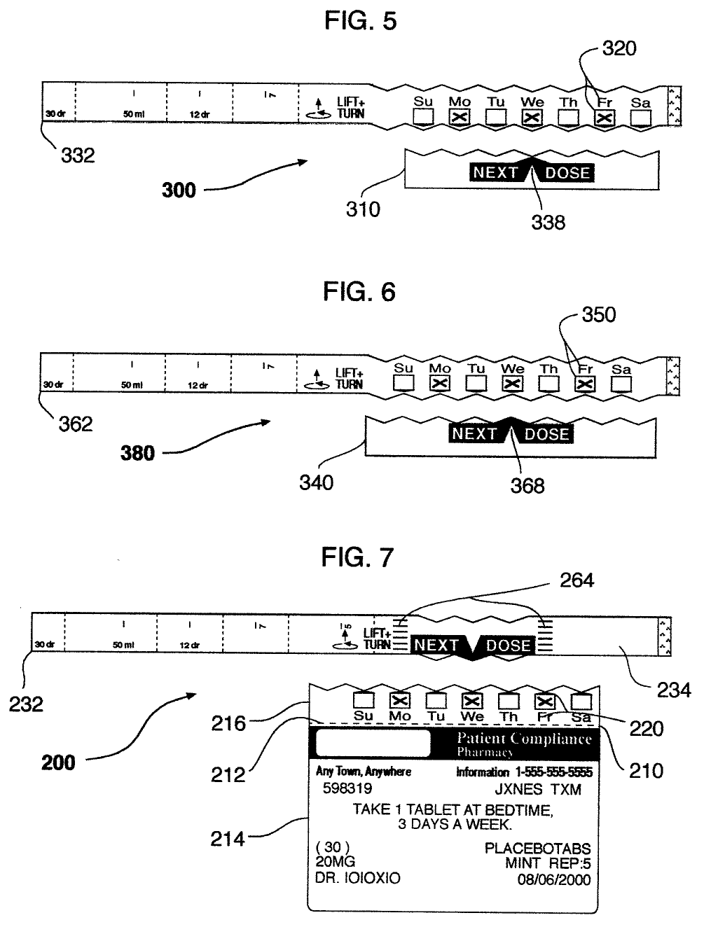

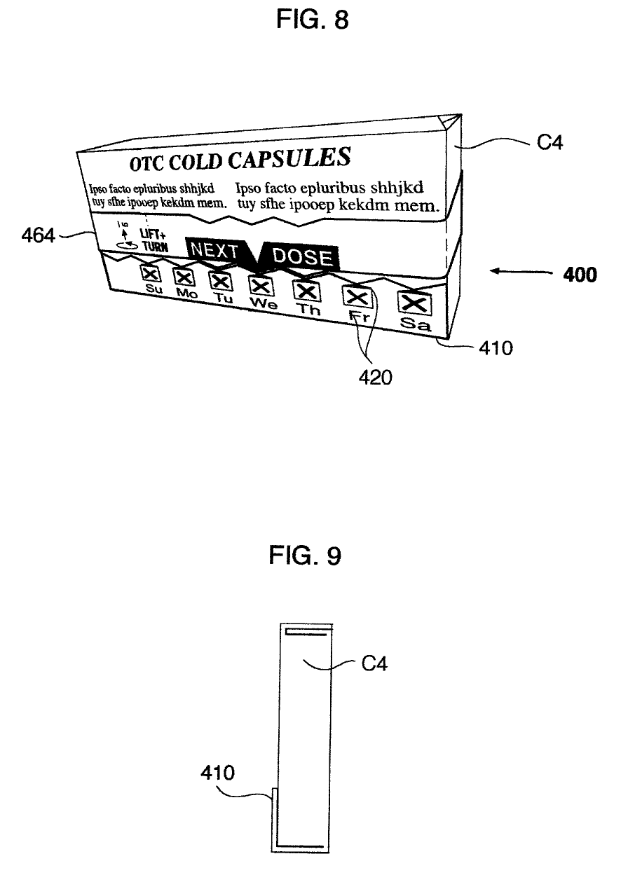

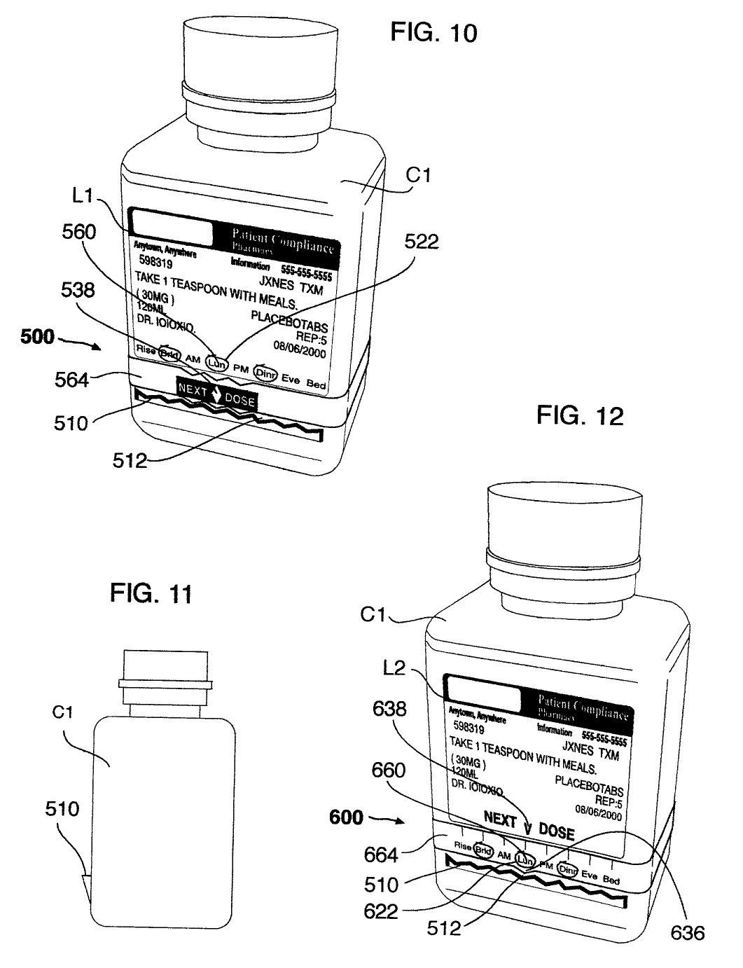

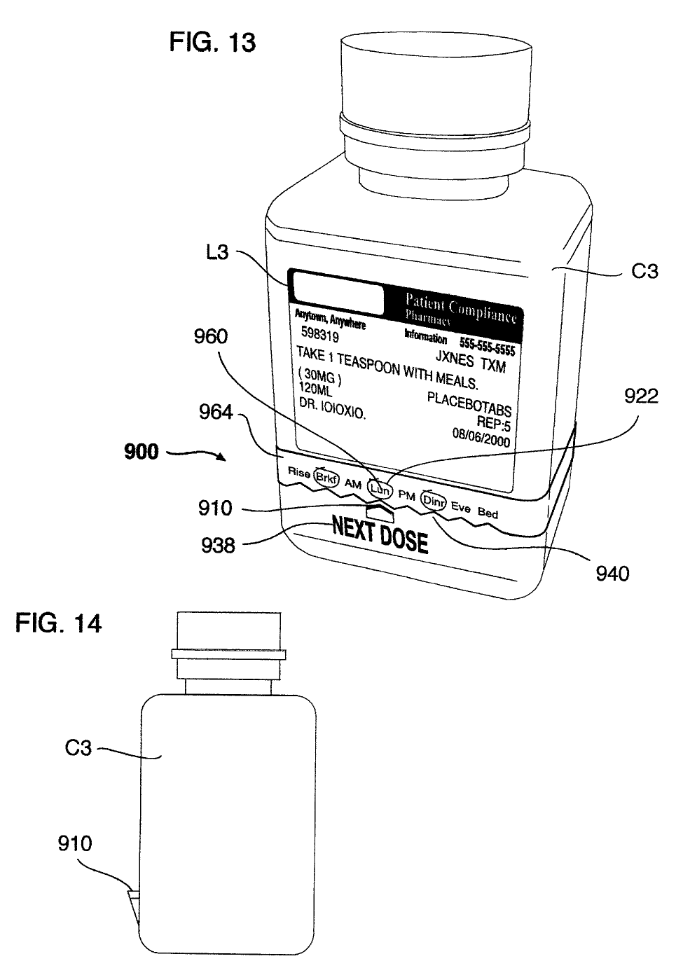

Reference Numerals in Drawings

| C | Container (vial) | (FIGS. 1, 4A, 4B) |
|---|---|---|
| C1 | Container (bottle) | (FIGS. 10, 11, 12) |
| C3 | Container (bottle) | (FIGS. 13, 14) |
| C4 | Cardboard Carton Container | (FIGS. 8, 9) |
| L | Prescription Label | (FIG. 1, 4A, 4B) |
| L1 | Prescription Label | (FIG. 10) |
| L2 | Prescription Label | (FIG. 12) |
| L3 | Prescription Label | (FIG. 13) |
| 100 | Reminder Device | (FIGS. 1, 2, 4A, 4B) |
| 110 | Band Support | (FIGS. 1, 2, 4A, 4B) |
| 112 | Band Support Notches | (FIGS. 1, 2) |
| 114 | Band Support Upper Perimeter | (FIGS. 1, 2) |
| 116 | Band Support Front Surface | (FIGS. 1, 2, 4A, 4B) |
| 118 | Band Support Back Surface | (FIG. 4B) |
| 120 | Scheduling Indicia | (FIGS. 1, 2) |
| 122 | Schedule Mark | (FIGS. 1, 2) |
| 124 | Band Support Length | (FIG. 2) |
| 126 | Pressure Sensitive Adhesive | (FIG. 4A, 4B) |
| 128 | Longitudinal Axis | (FIG. 4A) |
| 132 | Band | (FIGS. 2, 3) |
| 132m | Mounted Continuous Band | (FIGS. 1, 4A, 4B) |
| 134 | Band Front Surface | (FIGS. 1, 2, 3) |
| 136 | Teeth | (FIGS. 1, 2, 3) |
| 138 | Next Dose Pointer | (FIGS. 1, 2, 3) |
| 140 | Band Notches | (FIGS. 1, 2, 3) |
| 142 | Band Use Instructions | (FIGS. 1, 2, 3) |
| 144 | Crease Mark | (FIGS. 2, 3) |
| 146 | Trim Mark | (FIG. 2) |
| 148a | Band End a | (FIGS. 2, 3) |
| 148b | Band End b | (FIGS. 2, 3) |
| 150 | Spot Pressure Sensitive Adhesive | (FIGS. 2, 3) |
| 152 | Band Upper Perimeter | (FIGS. 1, 2, 3) |
| 154 | Band Lower Perimeter | (FIGS. 1, 2, 3) |
| 156 | Band Length | (FIG. 2) |
| 158 | Container Size Mark | (FIGS. 2, 3) |
| 160 | Notch & Tooth Distance From End | (FIG. 2) |
| 162 | Band Back Surface | (FIG. 3) |
| 200 | Reminder Device | (FIG. 7) |
| 210 | Band Support-Prescription Label | (FIG. 7) |
| 212 | Perforation | (FIG. 7) |
| 214 | Prescription Label Section | (FIG. 7) |
| 216 | Band support Section | (FIG. 7) |
| 220 | Scheduling Indicia | (FIG. 7) |
| 232 | Band | (FIG. 7) |
| 234 | Band Front Surface | (FIG. 7) |
| 264 | Spot Rubber Gripper | (FIG. 7) |
| 300 | Reminder Device | (FIG. 5) |
| 310 | Band Support | (FIG. 5) |
| 320 | Scheduling Indicia | (FIG. 5) |
| 332 | Band | (FIG. 5) |
| 338 | Next Dose Pointer | (FIG. 5) |
| 340 | Band Support | (FIG. 6) |
| 350 | Scheduling Indicia | (FIG. 6) |
| 362 | Band | (FIG. 6) |
| 368 | Next Dose Pointer | (FIG. 6) |
| 380 | Reminder Device | (FIG. 6) |
| 400 | Reminder Device | (FIG. 8) |
| 410 | Integral Band Support | (FIGS. 8, 9) |
| 420 | Scheduling Indicia | (FIG. 8) |
| 464 | Mounted Continuous Band | (FIG. 8) |
| 500 | Reminder Device | (FIG. 10) |
| 510 | Integral Band Support | (FIGS. 10, 11, 12) |
| 512 | Band Support Notches | (FIGS. 10, 12) |
| 522 | Schedule Mark | (FIG. 10) |
| 538 | Next Dose Pointer | (FIG. 10) |
| 560 | Scheduling Indicia | (FIG. 10) |
| 564 | Mounted Continuous Band | (FIG. 10) |
| 600 | Reminder Device | (FIG. 12) |
| 622 | Schedule Mark | (FIG. 12) |
| 636 | Tooth | (FIG. 12) |
| 638 | Next Dose Pointer | (FIG. 12) |
| 660 | Scheduling Indicia | (FIG. 12) |
| 664 | Mounted Continuous Band | (FIG. 12) |
| 900 | Reminder Device | (FIG. 13) |
| 910 | Integral Band Support | (FIGS. 13, 14) |
| 922 | Schedule Mark | (FIG. 13) |
| 938 | Next Dose Pointer Indicia | (FIG. 13) |
| 940 | Band Notches | (FIG. 13) |
| 960 | Scheduling Indicia | (FIG. 13) |
| 964 | Mounted Continuous Band | (FIG. 13) |

### DESCRIPTION AND OPERATION

### FIGS. 1 through 4B—Preferred Embodiment

With reference now to FIGS. 1 through 4B, a preferred embodiment of the medication dosage reminder device is generally illustrated at 100.

The reminder device is formed from two parts or members: a substantially rectilinear band support 110 and a substantially rectilinear band 132 (FIG. 2). The band support and the band are preferably manufactured from flexible sheet stock or roll stock such as paper, cardboard or plastic and may be punched, cut, or similarly manufactured. Material otherwise manufactured would also work in many applications. The band support could also be manufactured from more rigid material for many applications so long as the resultant band support is sufficiently thick to support the band.

The band support has a plurality of abutted triangle-shaped notches 112 (FIGS. 1, 2) having the band support upper perimeter 114 as their base. The band support notches are arranged across entire length 124 (FIG. 2) of the band support. These notches are shaped to mate with or engage teeth 136 on the band as described below. Printed on the front surface 116 of the band support are indicating scheduling indicia 120 consisting of days of the week and corresponding boxes that may be inscribed by the pharmacist or user. The notches permanently reference the indicia so that a single notch is associated with a single day of the week. A patient establishes his customized dosage schedule in accordance with prescription label L (FIG. 1) instructions by marking or inscribing 122 the scheduling indicia by pen or marker or like means. Back surface 118 (FIG. 4B) of the band support retains a coating of pressure sensitive adhesive 126. The pressure sensitive adhesive serves to attach the band support to medication container C.

The band has a plurality of abutted triangle-shaped notches 140 (FIGS. 1, 2) having the band upper perimeter 152 as their base. Equivalent teeth 136, equal in number to band notches 140, and having lower perimeter 154 of the band as their base, extend from the lower perimeter of the band. Each tooth on the band is aligned with a corresponding notch on the band so that they are both positioned at an equal distance 160 (FIG. 2) from same end 148b of the band. One of the teeth serves as a next dose pointer 138 and is so indicated. Indicia on the band indicate where to trim or cut 146 the length of the band with scissors in order to fit a particular size 158 of container and where to crease 144 the band to facilitate mounting. Instructions 142 for manipulating the mounted band also appear on the band. Front surface 134 of the band retains spot pressure sensitive adhesive 150 at one end 148b of the band.

The device is assembled on the surface of the medication container by attaching the band support and mounting the band around the medication container in separate steps. The band support is attached to the wall surface of the container in a straight manner so that the entire upper perimeter of the band support rests at more or less the same height on the container. In general practice the band support is placed near the bottom of the container but it may be positioned elsewhere. It may be attached anywhere, either directly on the surface of the container or on top of the attached prescription label, so long as sufficient space is left above the band support to permit both mounting and operational displacement of the band.

In preparation for its mounting, band length 156 (FIG. 2) may be cut, if necessary, by the pharmacist or user at an indicated trim mark 146 with scissors in order to properly fit the size of container being employed. The band is then closely fitted around the container just above the band support and creased in the direction of the container, at the indicated crease mark closest to the band end. The location of band end and the associated crease mark of coarse varies, depending upon where and if the band length is cut. Back surface 162 (FIG. 3) of overlapping end 148a of the band is pressed onto front surface 134 of other end 148b of the band. The ends are joined by spot pressure sensitive adhesive 150 between the two surfaces, forming a loop or continuous band 132m (FIG. 1).

Referring to the assembled device in FIG. 1 and the illustration in FIGS. 4A and 4B. A mounted continuous band 132m is axially displaceable above the band support, along longitudinal axis 128 (FIG. 4A) of the medication container, over the outer surface of the container. It is also free to rotate about the container when teeth 136 (FIG. 1) extending from its lower perimeter 154 are not engaged with any band support notches 112 at the band support's upper perimeter. Because the mounted continuous band is closely fitted around the medication container, downward displacement of the mounted band along the longitudinal axis is limited by contact with the band support.

When a patient takes her medication she aligns the next dose pointer on the mounted band with the inscribed next dosage time period on the band support. This is accomplished by sliding the mounted band upward along the longitudinal axis of the container to disengage it from the band support, rotating the band to align the pointer, and sliding the mounted band downward to re-engage the band support. The next dose pointer and the inscribed time period indicia form a reminder indicating when the next dose is due or when the last dose was taken.

Minor variations of this embodiment of the invention, two of which are generally illustrated at 300 (FIG. 5) and 380 (FIG. 6), will become readily apparent to those skilled in the art. These illustrations show bands 332 and 362 respectively printed with scheduling indicia 320 and 350 and band supports 310 and 340 respectively acting as pointers 338 and 368.

FIG. 7—Additional Embodiment

With reference now to FIG. 7, and FIGS. 1 through 3, an additional second embodiment of the medication dosage reminder device is generally illustrated at 200.

The reminder device is formed from two parts or members: a substantially rectilinear band support-prescription label 210 and a substantially rectilinear band 232.

A band support like 110 (FIGS. 1, 2) is manufactured having an integral pharmacy prescription label like L (FIG. 1). The new combined band support-prescription label has a prescription label section 214 (FIG. 7) below a band support section 216 and perforations 212 between the two sections. The two sections may be separated if desired by tearing one from the other or cutting along the perforations with scissors. The resultant sections after separating would yield a band support like the band support in the preferred embodiment and a pharmacy prescription label like the pharmacy prescription label in the preferred embodiment. Band support-prescription label 210 could be manufactured without preprinted dosage scheduling indicia 220, allowing for a great degree of individual customization by the pharmacist or patient. Procedure for establishment of the dosage time period schedule is the same as in the preferred embodiment of the invention. The combined band support label may be attached anywhere directly on the surface of the container, in the same manner as the band support in the preferred embodiment. As in the case of the original band support, sufficient space should be left above the combined band support label to permit both mounting and operational displacement of the band.

If a pharmacist chooses to separate the two sections of the combined label, the prescription label section could first be attached directly to the container just like a traditional prescription label. The band support section could then be attached on top of the prescription label section in a manner similar to that in the preferred embodiment and with the same considerations for the requirements of the band.

Band 232 in this embodiment is the same as band 132 (FIG. 2) in the preferred embodiment except that front surface 234 (FIG. 7) of the new band retains a spot coating of rubber 264 to facilitate gripping the band. Procedures for preparing band 232 for mounting and fitting the band around a container are the same as for band 132 in the preferred embodiment. Operation of reminder device 200 is the same as for reminder device 100 in the preferred embodiment.

FIGS. 8 and 9—Alternative Embodiments

With reference now to FIGS. 8 through 14 and FIGS. 1 through 3, an alternative third embodiment of the medication dosage reminder device is generally illustrated at 400 (FIG. 8), and variations thereof at 500 (FIG. 10), 600 (FIG. 12) and 900 (FIG. 13). The band support is integral to the container and in some of the variations, reference indicia produced on a pharmacy prescription label also form part of the device.

In this embodiment reminder device 400 (FIG. 8) includes a container C4 having an integral band support 410 on a wall and a mounted band 464 similar to band 132m (FIG. 1) in the preferred embodiment.

Referring now to FIGS. 8 and 9: reminder device 400 is similar to the original reminder device in FIG. 1. New band support 410 is similar to original band support 110, but requires no mounting since it is manufactured as an integral part of the container. In this example of a cardboard medication container C4, the integral band support is produced from an extra thickness of cardboard. The method for producing an extra thickness of cardboard by overlapping one section of a cardboard sheet with another section of the same sheet in manufacture or assembly is well known in the art associated with cardboard container manufacturing. Dosage scheduling indicia 420 may be printed directly on band support section 410 of the container at the same time as the rest of the information on the container. Alternatively, the dosage scheduling indicia may be applied to the band support section by way of a pressure sensitive adhesive label. The procedure for establishment of the dosage time period schedule is the same as in the preferred embodiment. Mounted continuous band 464 may be formed from band 132 (FIG. 2) used in the preferred embodiment and procedures for preparing the band for mounting and fitting the band around the container are also the same as in the preferred embodiment. Operation of reminder device 400 is the same as for reminder device 100 in the preferred embodiment

FIGS. 10 and 11 show a variation of the alternative third embodiment of the invention generally illustrated at 500 by way of a medication bottle container C1. Band support 510 is integral to the container. Dosage scheduling indicia 560 may be printed directly on pharmacy prescription label L1 along with the other usage information or may be preprinted on stocked pharmacy prescription labels. The spacing of indicia 560 on the label match the spacing of the band-support notches 512.

First the prescription label is attached to the container in a position that causes dosage scheduling indicia to reference the band-support notches while leaving sufficient space below the label for mounting and operational displacement of the band. The band is next prepared and mounted on the container in the same manner as in the preferred embodiment. Mounted continuous band 564 has a next dose indicator pointer 538 which in operation, the patient aligns with inscribed 522 scheduling indicia 560 on the label. All other procedures and operation of reminder device 500 is otherwise the same as for reminder device 400 (FIG. 8).

FIG. 12 illustrates a variation similar to that in FIG. 10 and is shown generally at 600. Next dose indicator pointer 638 is printed directly on prescription label L2 and the prescription label is positioned on container C1 so that the next dose indicator pointer references a notch 512 in band support 510. Mounted continuous band 664, which may be inscribed 622, has dosage scheduling indicia 660 printed so that one of the indicia line up with a tooth 636 and spacing of the indicia match spacing of the band-support notches. In operation, the patient aligns the inscribed indicia on the band with the pointer on the label. All other procedures for device 600 are otherwise the same as for device 500 (FIG. 10).

FIGS. 13 and 14 illustrate yet another variation of the alternative third embodiment of the invention generally at 900. Integral band support 910 however, is a tooth that also acts as the next dose indicator pointer and is so marked 938 directly on container C3. Label L3 is a standard pharmacy prescription label and is not part of the invention. Mounted continuous band 964, which may be inscribed 922, has dosage scheduling indicia 960 that reference notches 940 in the band. In operation, the patient aligns the inscribed indicia on the mounted band with the band-support pointer. All other procedures and operation of reminder device 900 are otherwise the same as for reminder device 400 (FIG. 8).

Advantages

My medication dosage reminder device has a number of advantages that are evident from the description above. Still other advantages will become apparent upon further consideration:

a) Broad applicability from a single version

My medication dosage reminder device works with most common medication containers in use today. These include bottles, cardboard cartons and vials, even many small vials with pharmacy prescription labels covering much of the surface. The band component of the reminder device is adjustable so that a single version of the device will fit a variety of container sizes. On small containers that use a traditional pharmacy prescription label, the band may be mounted over the pharmacy label and if necessary, be temporarily moved out of the way to read occluded information. The band may be manufactured of transparent material to further improve viewing of information beneath the mounted band.

b) Low cost

My medication dosage reminder device offers the advantage of very low cost of manufacture. In the additional second embodiment, the number of extra components required over a traditionally filled prescription has been reduced to one. My new “band support-prescription label” can be used in place of the usual pharmacy label. It fulfills the function of a band support that may be engaged in the reminder device, but can also act as the prescription label. It fits the same automated equipment as the traditional pharmacy label and is competitive in cost. Cost for the band, the one extra component, is about the same as a comparably sized pressure sensitive label. Furthermore, the placement of equivalent notches and teeth in the design of the band allows abutting of bands on the production sheet or roll. This results in minimal waste of material and reduced tooling costs.

c) Ease of use and safety

Assembling the device is similar to attaching a pressure sensitive adhesive label to a container, a task that pharmacists are quite familiar with and one that is easy for most anyone to accomplish. The device is simple to use, requiring little skill or dexterity. Device operation approximates the skills required to open a bottle. The procedure however, is easier because there is negligible resistance. The indicia are legible and uncrowded.

While engagement of the mounted band with the band support helps to prevent inadvertent dislocation of the pointer, the patient can engage and disengage these components at will. Device design also aids patients in achieving correct alignment when trying to select the next dosage time period.

Every additional step that a patient has to perform in maintaining a medication regimen hinders compliance and increases the potential for error. The device can retain a patient's entire customized dosage schedule. This relieves the need for the patient to reconfirm the next dose time period with the pharmacy label instructions every time a dose is taken. This contrasts sharply with devices that just use standard indicia such as all the days of the week, or all the hours in a day for example. If however, a patient wants to consult the pharmacy prescription label, it is reassuring to be able to view the device and the prescription label instructions at the same time. This arrangement is also less prone to errors than that for devices that don't have this capability.

d) Customizability

All embodiments of the invention allow for considerable customization of the patient dosage schedule. It is anticipated that two preprinted versions of dosage scheduling indicia could provide sufficient schedule variation capability to suit most patients. Customization options could be limitless by not preprinting the scheduling information. The additional second embodiment employs a band support incorporating an integral pharmacy prescription label. Computerized printing equipment currently in use by many pharmacies could print the required customized dosage schedule at the same time as usage instructions are printed on the prescription label. I am not aware of any other mass-market compliance aid that offers this degree of cost-effective customization.

Conclusions, Ramifications, and Scope

Thus the reader will see that the medication reminder device of the invention provides a very simple, effective, yet economical device that can be used by many patients of almost any age.

While my above descriptions contain many specificities, these should not be construed as limitations on the scope of the invention, but rather as exemplifications of embodiments thereof. Many other variations are possible.

For example; the specific shape of the band support and the band may be varied so long as one may be engaged with the other at a plurality of relative positions, and providing the band support is attached or attachable to the medication container while the band can be mounted on the container so as to be rotatable about the container. In the described and illustrated examples, structurally defined areas of engagement include a notch and a tooth, but the area of engagement could include, although not be limited to an aperture, bump, recess, protrusion, slit, ridge, deformation, etc.

It is contemplated that the band support adhesive and band adhesive could include, any attaching and joining means including various chemical adhesives, magnets, tapes, and mechanical couplers and fasteners.

It is contemplated that the attachable band support could be thicker or thinner than illustrated and that it could have equivalent structural shapes at its upper and lower perimeters like those used in the band in order to permit cost reductions in manufacture. The band support could be attached wholly or partly on top of the attached pharmacy prescription label.

It is also contemplated that the band support-prescription label could be produced without perforations and have equivalent structural shapes at its upper and lower perimeters like those used in the band.

It is also contemplated that the band could have more or less notches and more or less teeth than illustrated, and could have a different mounting procedure.

It is further contemplated that methods other than a rubber coating on the front surface of the band could be used to improve gripping of the mounted band. While not limited to the following, some of the methods contemplated are surface abrasion, processing to produce a textured surface, and folding to produce ridges or corrugations.

It is still further contemplated that the device might be useful in non-medical applications where tasks are repeated at intervals and a simple, inexpensive reminder device would be of help.

Finally, it is contemplated that the dosage time period indicia might indicate times or time periods larger or smaller than those illustrated. Even a different scale might be used to represent members of a set, such as people, places, or things.

Accordingly, the scope of the invention should be determined not by the embodiments illustrated, but by the appended claims and their legal equivalents.

What I claim as my invention is:

1. A device for indicating a medication dosage time, the device comprising:
a. a medication container having a curved exterior side surface;
b. a band member, the band being deformable, and defining a structural area for engagement;
c. means for mounting said band member continuously around the curved exterior side surface of said container such that said mounted band may be rotated about said container;
d. a band support member defining a structural area adapted to receive engagement therewith said band member;
e. means for attaching said band support member to said medication container;
f. co-operating indicia on the band member and the band support member for indicating a medication dosage time, whereby a patient can be greatly assisted in following a medication dosage regimen.

2. A device as in claim 1 wherein the co-operating indicia includes:
a. an arrangement of times on said band support member; and
b. a pointer on said band member adapted to point to any one of said times.

3. A device as in claim 1 wherein the co-operating indicia includes:
a. an arrangement of times on said band member; and
b. a pointer on said band support member adapted to point to any one of said times.

4. A device as in claim 1 wherein the indicia may be inscribed.

5. A device as in claim 1 wherein the band support member is adhesively attached to said medication container.

6. A device as in claim 1 wherein the band member is adhesively formed into a continuous band.

7. A device as in claim 1 wherein the band member has gripping means to aid grasping said band for displacement.

8. A device as in claim 1 wherein the band support member has anti-displacement means for limiting displacement of said band member.

9. A device as in claim 5 wherein the medication container is substantially cylindrical.

10. A device as in claim 1 wherein the band support member is integrally combined with a prescription label.

11. A device as in claim 10 wherein said band support-prescription label is adhesively attached to said medication container.

12. A device as in claim 10 wherein said band support-prescription label may be mechanically separated into a band support and a prescription label.

13. A method for indicating a medication dosage time, comprising:
a. providing a container of medicine, the container having a curved exterior surface;
b. providing a band member, the band being deformable and defining a structural area for engagement;
c. providing a band support member defining a structural area adapted to receive engagement therewith said band member, where said band and said band support include co-operating indicia for indicating a medication dosage time;
d. attaching said band support member to said medication container;
e. mounting said band member continuously around the curved exterior side surface of said container such that said mounted band may be rotated about said container;
f. rotating said mounted band about said container until the co-operating indicia indicate a desired medication time.

14. A method as in claim 13 wherein the step of attaching includes attaching the band support member with adhesive.

15. A method as in claim 13 wherein the co-operating indicia includes:
a. an arrangement of times on said band support member; and
b. a pointer on said band member adapted to point to any one of said times.

16. A method as in claim 13 wherein the co-operating indicia includes:
a. an arrangement of times on said band member; and
b. a pointer on said band support member adapted to point to any one of said times.

17. A method as in claim 13 wherein said step of mounting is performed prior to said step of attaching.

18. A device for indicating a medication dosage time, the device comprising:
a. a band member, the band being deformable and defining a structural area for engagement;
b. a medication container, the container being substantially cylindrical and having an exterior side surface such that;
1. said side surface defines a structural area adapted to support thereby said band,
2. said side surface defines a structural area adapted to receive engagement therewith said band.
c. means for mounting said band member continuously around the exterior side surface of said container such that said mounted band may be rotated about said container;
d. co-operating indicia referencing positions on the medication container and the band for indicating a medication dosage time period, whereby a patient can be greatly assisted in following a medication dosage regimen.
